(19) United States
(12) Patent Application Publication
(10) Pub. No.: US 2022/0274191 A1
(43) Pub. Date: Sep. 1, 2022

(54) Saw Tool

(71) Applicant: Robert Bosch GmbH, Stuttgart (DE)

(72) Inventors: Heinrich Lauber, Zermatt (CH); Gerald Ducrey Nendaz, Ayent (CH); Fabian Mooser, Täsch (CH); Sebastian Burgener, Visperterminen (CH); Martin Anthamatten, Grächen (CH); Martin Imboden, Nklaus (CH)

(21) Appl. No.: 17/638,262

(22) PCT Filed: Sep. 3, 2020
(86) PCT No.: PCT/EP2020/074543

§ 371 Date: Feb. 25, 2022

(30) Foreign Application Priority Data
Sep. 4, 2019 (DE) 10 2019 213 382.7

(51) Int. Cl. B23D 61/00

(52) U.S. Cl. CPC B23D 61/006

(57) ABSTRACT

The disclosure relates to a saw tool, in particular a saw blade, for a machine tool, in particular an oscillating multifunctional machine tool, comprising at least one iron-containing support and at least one tungsten-containing hard metal strip which has a strip connection edge, wherein the at least one hard metal strip is bonded to the support at the strip connection edge via a diffusion connection which has at least one diffusion zone. The strip connection edge is designed to be at least substantially curved, in particular along a circular arc.

### PRIOR ART

A saw tool is already known from DE 10 2011 103 880 B4.

### DISCLOSURE OF THE INVENTION

The invention is based on a saw tool, in particular a saw blade, for a power tool, in particular a multifunctional power tool that can be driven in oscillation, comprising at least one iron-containing carrier and at least one tungsten-containing hard metal strip that has a strip connection edge, wherein the at least one hard metal strip is connected to the carrier at the strip connection edge in a materially bonded manner via a diffusion joint that has at least one diffusion zone.

It is proposed that the strip connection edge be at least substantially curved, in particular along a circular arc. That an edge and/or an outer contour is at least “substantially curved”, it is to be understood to mean, in particular, that the edge and/or outer contour is arranged, in particular entirely, within a first and a second notional arc segment, in particular two circles and/or two ellipses, an arc distance of the first arc segment from the second notional arc segment measuring maximally 25%, preferably maximally 15%, and very particularly preferably maximally 12.5% of the distance of the larger arc segment from a mid-point of the circle or ellipse, and the arc segments being in particular parallel to each another. It is conceivable for the radii of the first and a second notional arc to differ from each other by less than 5%, in particular less than 1%, of the radius of the larger arc.

Preferably, the carrier, in particular in a region that faces away from the diffusion zone, has a machine interface for a connection to the power tool, in particular to the multifunctional power tool that can be driven in oscillation. Preferably, the machine interface is designed for connection to a tool receiver of the power tool, in particular to a tool receiver of the multifunctional power tool that can be driven in oscillation. The tool receiver is realized as an interface of the power tool for connection to at least one tool, in particular to the saw tool.

Preferably, the tool receiver of the power tool has at least one tool seating surface against which the saw tool can be placed. Preferably, the tool receiver comprises at least one axial securing element for axially securing the saw tool to the tool seating surface, in particular in a non-positive and/or positive manner. Preferably, the tool receiver comprises at least one torque transmission element for transmitting a torque to the saw tool. The torque transmission element may be realized, for example, as at least one pin projecting from the tool seating surface. Preferably, the tool receiver has a multiplicity of torque transmission elements, for instance eight, ten or twelve. It is also conceivable for the tool receiver to have at least one axial securing element designed to exert a magnetic force on an object to be coupled. It is conceivable for the tool receiver to comprise at least one permanent magnet that is aligned and/or arranged to exert the magnetic force. In particular, the tool receiver may be realized in a manner similar to a tool receiver according to EP 3 027 361 A1, EP 3 02 7362 A1 or EP 3 027 367 A1.

Preferably, the machine interface has at least one connection element, in particular a plurality of connection elements, in particular recess(es), for receiving at least one pin of a tool receiver of the power tool. Preferably, the machine interface is realized as at least one recess, in particular as a through-hole, on/in the carrier. Preferably, the machine interface has a central recess that, in particular, is larger than the at least one recess. Preferably, the machine interface is designed for precisely fitting connection to the tool receiver, in particular of the power tool. Preferably, the machine interface is designed for detachable connection to the power tool. It is conceivable for the machine interface and the tool receiver to be designed for connection by means of twisting and/or sliding and/or by means of plugging together. A mid-point of the machine interface may realize, for example, the mid-point of the circle and/or the ellipse, in particular the arc center, in particular around which the strip connection edge, in particular the carrier connection edge, is curved. It is conceivable, in particular in the case of an asymmetrically realized machine interface, for the mid-point of the circle and/or of the ellipse, in particular the arc center, to be arranged at a distance from a mid-point of the machine interface.

Preferably, the carrier, in the direction of the hard metal strip, has a carrier connection edge that is at least substantially curved. Preferably, the carrier connection edge and the strip connection edge are arranged substantially parallel to each other, in particular at least in sections. “Substantially parallel” is to be understood to mean, in particular, an alignment of a direction relative to a reference direction, in particular in a plane, the direction deviating from the reference direction by, in particular, less than 8°, advantageously less than 5°, and particularly advantageously less than 2°.

Preferably, the hard metal strip has a tungsten component of at least 10%, preferably at least 50%, particularly preferably at least 70%, and very particularly preferably at least 80%. Preferably, the hard metal strip has a cobalt component of at least 1%, preferably at least 5%, very particularly preferably at least 10%. Preferably, the hard metal strip has a tungsten carbide component of more than 75%, in particular of at least 80%, preferably of at least 85%. Preferably, the hard metal strip has a tungsten carbide component with tungsten carbide grain sizes of from 0.4 μm to 30 μm. Preferably, the hard metal strip has a binder, such as cobalt or nickel, that with the tungsten carbide component realizes at least substantially the entire hard metal strip. Preferably, the hard metal strip has a cobalt component, in particular as a binder, that with the tungsten carbide component realizes at least substantially the entire hard metal strip. It is conceivable for the hard metal strip to have chromium components or titanium components, in particular as a binder, of at most 2%. It is conceivable for the hard metal strip to have further carbide components, such as a chromium carbide component or titanium carbide components, in particular as a binder, of at most 2%. Preferably, the binder is composed of 4% to 30% fine-grained cobalt powder or nickel powder. It is conceivable for the hard metal strip to comprise a vanadium carbide component, chromium carbide component or another metallic hard material as special alloy elements. Preferably, the carrier has an iron component of at least 10%, preferably at least 70%, particularly preferably at least 90%. It is conceivable for the carrier and/or the hard metal strip to have a carbon component, in particular of at least 0.2%, preferably at least 0.5%, particularly preferably at least 1%, and in particular at most 5%, preferably at most 2.1%, and preferably at most 50%.

Preferably, the hard metal strip has a maximum extent, perpendicularly to the strip connection edge, that substantially measures at most 2 cm, preferably at most 1 cm, particularly preferably at most 0.5 cm, and very particularly preferably at most 0.2 cm. Preferably, the at least one hard metal strip and the at least one carrier have substantially equal maximum material thicknesses, in particular perpendicularly to their planes of main extent. That an extent or a value “substantially measures [a defined value]” and/or an extent or a value “substantially equals [a defined value]” is to be understood to mean, in particular, that an extent or a value corresponds to/equals a defined value except for production and assembly tolerances. It is conceivable for the at least one hard metal strip and the at least one carrier to have different maximum material thicknesses from each other, in particular perpendicularly to their planes of main extent. The, in particular different, maximum material thicknesses of the at least one hard metal strip and of the at least one carrier are preferably connected to each other via the diffusion joint at the strip connection edge, the at least one diffusion zone of the diffusion joint having at least one strip region that faces toward the at least one hard metal strip, and having at least one carrier region that faces toward the at least one carrier. Preferably, the at least one diffusion zone in the at least one strip region has a maximum material thickness, in particular a same maximum material thickness as the at least one hard metal strip, that is substantially equal to the maximum material thickness of the carrier. It is conceivable for the at least one diffusion zone in the at least one strip region to have a maximum material thickness, in particular a same maximum material thickness as the at least one hard metal strip, that is in particular different from a maximum material thickness in the at least one carrier region, in particular from a same maximum material thickness as the maximum material thickness of the at least one carrier. Preferably, the diffusion zone has an at least substantially homogeneous material thickness. Preferably, the hard metal strip, the carrier and the diffusion zone each have a maximum material thickness of at most 1 cm, preferably at most 0.5 cm, particularly preferably at most 0.3 cm. A “plane of main extent” of an object is to be understood to mean, in particular, a plane that is parallel to a largest lateral face of a smallest notional cuboid that only just completely encloses the object.

Preferably, the diffusion zone has a maximum extent of at most 3 cm, preferably at most 0.5 cm, particularly preferably at most 0.3 cm, and very particularly preferably at most 0.2 cm, from the strip connection edge in the direction of the carrier connection edge. It is conceivable for the diffusion zone to have a maximum extent of at most 0.15 cm or at most 0.12 cm from the strip connection edge in the direction of the carrier connection edge. Preferably, the diffusion zone has an at least substantially homogeneous, in particular equal, extent from the strip connection edge in the direction of the carrier connection edge, in particular over the maximum extent of the strip connection edge.

Preferably, the at least one diffusion zone is realized as a metal alloy of at least tungsten, cobalt and iron, the tungsten component in the at least one diffusion zone being in particular between 1% and 25%, preferably between 6% and 22%, particularly preferably between 4% and 19%. It is conceivable for the diffusion zone to have a maximum average hardness of at most 850 HV 0.5.

It is conceivable for the diffusion zone to have a minimum average tungsten component of at least 5%. It is conceivable for the diffusion zone to comprise further elements, in particular non-metallic elements. Preferably, the diffusion joint, in particular the diffusion zone, is realized by a heat treatment, in particular heat supply, in a thermal joining process such as, for example, in a soldering process, welding process, in particular laser welding process, arc welding process, electron beam welding process or inert gas welding process. Preferably, the diffusion zone has a carbon component that in particular is at least 0.2%, preferably at least 0.5%, particularly preferably at least 1%, and in particular at most 5%, preferably at most 2.1%. “A carbon component”, in particular “an element component”, is to be understood to mean, in particular, a carbon component in percentage by weight. Preferably, the diffusion zone has a cobalt component that in particular is at least 0.1%, preferably at least 0.5%, particularly preferably at least 0.9%, and in particular at most 5%, preferably at most 2.5%. Preferably, the diffusion zone has a minimum extent between the at least one hard metal strip and the at least one carrier of at least 100 μm, preferably at least 200 μm, particularly preferably at least 300 μm, and very particularly preferably at least 400 μm. Preferably, the diffusion zone has a profile of the tungsten component that decreases from the hard metal strip in the direction of the carrier, in particular that decreases logarithmically as the distance from the hard metal strip increases. Preferably, the diffusion zone has a maximum tungsten component of 19% at a maximum distance of at most 0.2 mm from the strip connection edge. Preferably, the diffusion zone has a minimum tungsten component of at least 14% at a maximum distance of at most 0.2 mm from the strip connection edge. Preferably, the diffusion zone has a minimum tungsten component of at least 4% at a maximum distance of between 0.2 mm and 0.35 mm from the strip connection edge. Preferably, the diffusion zone has a maximum tungsten component of at most 8% at a distance of between 0.2 mm and 0.35 mm from the strip connection edge. Preferably, the diffusion zone has a minimum tungsten component of at least 1% at a distance of between 0.35 mm and 0.41 mm from the strip connection edge. Preferably, the diffusion zone has a maximum tungsten component of at most 4% at a distance of between 0.35 mm and 0.41 mm from the strip connection edge. Preferably, the diffusion zone has a tungsten component of from 4% to 15% at a maximum distance of between 0.2 mm and 0.30 mm from the strip connection edge. Preferably, the diffusion zone has a cobalt component of from 0.9% to 2.5% at a maximum distance of between 0.2 mm and 0.30 mm from the strip connection edge.

Preferably, the diffusion zone has a maximum hardness of, in particular, at most 893 HV 0.5. Preferably, the diffusion zone has a minimum hardness of, in particular, at least 427 HV 0.5. Preferably, the diffusion zone has an increasing profile of hardness, in particular measured in HV 0.5, from the hard metal strip in the direction of the carrier. Preferably, the diffusion zone has an increasing profile of hardness, from the hard metal strip in the direction of the carrier, with at least two plateau regions in which the hardness is at least substantially constant. Preferably, the diffusion zone has a minimum hardness of at least 427 HV 0.5 at a maximum distance of at most 0.17 mm from the strip connection edge. Preferably, the diffusion zone has a maximum hardness of at most 441 HV 0.5 at a maximum distance of at most 0.17 mm from the strip connection edge. Preferably, the diffusion zone has a minimum hardness of at least 851 HV 0.5 at a distance of at least 0.26 mm and at most 0.41 mm from the strip connection edge. Preferably, the diffusion zone has a maximum hardness of at most 893 HV 0.5 at a distance of at least 0.26 mm and at most 0.41 mm from the strip connection edge. Preferably, the diffusion zone has a minimum hardness of at least 427 HV 0.5 at a distance of at least 0.17 mm and at most 0.26 mm from the strip connection edge. Preferably, the diffusion zone has a maximum hardness of at most 893 HV 0.5 at a distance of at least 0.17 mm and at most 0.26 mm from the strip connection edge. Preferably, the diffusion zone has an increasing, in particular at least substantially linearly increasing, profile of hardness, in particular measured in HV 0.5, at a distance of at least 0.17 mm and at most 0.26 mm. Preferably, the diffusion zone has a lesser hardness, of in particular at most 600 HV 0.5, at a distance of 0.2 mm than at a distance of 0.23 mm, in which the hardness is in particular at most 760 HV 0.5. Preferably, the hard metal strip has the same hardness, in particular measured in HV 0.5, at its outer edges, in particular at the cutting edge and strip connection edge. It is conceivable for the hard metal strip to have different hardnesses, in particular measured in HV 0.5, at its outer edges, in particular at the cutting edge and strip connection edge, in particular if the minimum extent of the hard metal strip between the cutting edge and the strip connection edge is greater than 5 mm.

The saw tool design according to the invention makes it possible to achieve advantageous properties of a joint between the hard metal strip and the carrier. An advantageously durable joint between the hard metal strip and the carrier can be realized.

It is also proposed that the strip connection edge extend over a segment angle of at least 15°. It is conceivable for the at least one strip connection edge to extend over a circular segment having a segment angle of at least 17.5°, preferably at least 25°, particularly preferably at least 30°, and very particularly preferably at least 45°, in particular in a parallel manner. An advantageous alignment of joining forces, in particular of the diffusion joint, that realize an angle of less than 90°, in particular in dependence on a sawing angle, can be achieved at the strip connection edge.

It is also proposed that the diffusion zone have two end edges that are located at the end regions of the maximum extent of the strip connection edge, wherein the end edges are of at least substantially equal, in particular maximum, lengths. That “the end edges are of at least substantially equal lengths” it is to be understood to mean that the end edges are of equal, in particular maximum, lengths up to at most 0.5 cm, preferably at most 0.2 cm, particularly preferably at most 0.05 cm, and very particularly preferably at most 0.02 cm.

It is conceivable for the diffusion zone to have two end edges that are arranged at the end regions of the maximum extent of the strip connection edge, the end edges having different, in particular maximum, lengths, of in particular more than 1 cm. Preferably, the end edges are spaced apart from each other by a length of a longest edge of a smallest geometric cuboid that only just completely encloses the strip connection edge. Preferably, the end edges are straight, in particular perpendicularly to the maximum extent of the strip connection edge. Preferably, the end edges each have a plane of main extent. Preferably, the planes of main extent of the end edges realize at least the segment angle, in particular of at least 15°, with respect to each other. It is conceivable for the end edges to be curved, in particular at least substantially concave or convex, in particular with respect to the respectively other end edge. It is conceivable for the end edges to be symmetrically curved. It is conceivable for the end edges to be asymmetrically curved, in particular not to have a single radius of curvature. It is conceivable for the end edges to be of the same shape, in particular having at least substantially the same symmetries, in a notional rotation. It is conceivable for the diffusion zone to have an extent, from the strip connection edge in the direction of the carrier connection edge, that is longer in the vicinities of one or both end edges than in a region between the vicinities of the end edges.

The diffusion zone preferably has two main end edges that extend between the end edges over the maximum extent of the strip connection edge. The main end edges are preferably arranged on an outer face of the diffusion zone. It is conceivable for the main end edges to be of at least substantially equal, in particular maximum, lengths. It is conceivable for the main end edges of the diffusion zone to be realized in a manner similar to the end edges of the diffusion zone. It is possible to realize an advantageously stable diffusion joint that is realized in a homogeneous manner in outer regions, in particular in lateral regions. An advantageously uniform load can be achieved in a sawing operation with the saw tool. Advantageous reductions in load stresses can be achieved in a sawing operation, in particular with a saw tool that extends over a segment angle of at least 15°. An advantageously uniform appearance can be achieved.

It is furthermore proposed that the at least one hard metal strip have, opposite the at least one strip connection edge, at least one cutting edge on which cutting teeth are arranged and which extends over a circular segment having a segment angle of at least 15°. Preferably, the at least one cutting edge is substantially curved. Preferably, the at least one cutting edge is substantially parallel, in particular at least in sections, to the strip connection edge. Preferably, the at least one cutting edge has a maximum distance of at most 5 cm, preferably at most 2 cm, particularly preferably at most 1 cm, and very particularly preferably at most 0.5 cm from the strip connection edge. Preferably, the hard metal strip has saw teeth that are realized as a single piece, in particular as a single part, with the hard metal strip. “As a single piece” is to be understood to mean, in particular, connected in a materially bonded manner, as for example by a welding process and/or adhesive process, etc., and particularly advantageously integrally formed, as by production from a casting and/or by production in a single-component or multi-component injection molding process. It is conceivable for the saw teeth to be realized as a surface structure in the hard metal strip at the cutting edge, as for example by a forming process such as, for instance, a stamping process, a punching process or a grinding process. It is conceivable for the at least one cutting edge to extend over a circular segment having a segment angle of at least 15°, preferably at least 25°, particularly preferably at least 30°, and very preferably at least 45°, in particular parallel to the strip connection edge. Preferably, the cutting edge extends over the same segment angle as the strip connection edge. Advantageous sawing characteristics can be achieved. In particular, it is possible to achieve periodic pivoting of the saw blade with an advantageously low frequency, for example for sawing up objects. In particular, an advantageous resistance to wear, especially at the machine interface, can be achieved. An advantageously energy-saving saw tool can be achieved, in particular due to a low pivoting frequency of the saw tool.

It is additionally proposed that the strip connection edge be at least substantially undulated. It is conceivable for the strip connection edge to realize at least substantially a zigzag shape and/or sawtooth shape or the like. It is conceivable for the strip connection edge to realize different shapes in sections, such as straight, curved or structured shapes, in particular for the purpose of realizing a connection surface to the at least one carrier. It is conceivable for the strip connection edge to have a combination of different shapes, the strip connection edge preferably extending between two notional, in particular parallel, arc segments having a maximum spacing of at most 3 cm, preferably at most 2 cm, particularly preferably at most 1 cm. Preferably, the carrier connection edge is of an undulated shape that is offset so as to correspond to the strip connection edge, in particular for precisely fitting connection of a wave trough of the strip connection edge/carrier connection edge to a wave crest of the carrier connection edge/strip connection edge. A strip connection edge can be achieved that is advantageously longer, in particular compared to a strip connection edge that follows an arc segment in a straight line. Advantageously, the stability of the diffusion joint along the strip connection can thereby be increased.

It is also proposed that the at least one hard metal strip have at least one cutting edge opposite the at least one strip connection edge, wherein the cutting edge and the strip connection edge are on average at least substantially parallel to each other, and wherein the strip connection edge has a lesser maximum extent than the cutting edge. That two edges are “on average [. . . ] parallel” to each other is to be understood to mean, in particular, that the mean courses of two edges are parallel to each other, in particular at least substantially. A “mean course” of an edge is to be understood to mean, in particular, a notional line that has the least quadratic distance from all sections of the edge. The cutting edge preferably extends over at least the same, in particular a larger, segment angle as/than the strip connection edge. Preferably, the strip connection edge has a lesser maximum extent, by at least 0.1 cm, preferably 0.2 cm, particularly preferably 0.5 cm, very particularly preferably at least 1 cm, than the cut edge. It is conceivable for the strip connection edge to have a greater maximum extent than the cutting edge. It is conceivable for the strip connection edge to extend over a greater segment angle than the cutting edge. An advantageous long cutting edge of a saw tool can be achieved. It is possible to achieve an advantageous alignment of an application of force upon the curved saw tool, in particular the curved diffusion joint, in a sawing operation. It is possible to achieve an advantageous distribution of applied force perpendicularly to the diffusion joint.

It is also proposed that the at least one hard metal strip have at least one cutting edge opposite the at least one strip connection edge, wherein the at least one cutting edge has a continuous, curved shape that is at least substantially parallel to the at least one strip connection edge, wherein the at least one strip connection edge and the at least one cutting edge each extend over a circular segment having a segment angle of at least 15°. Preferably, the at least one cutting edge and the at least one strip connection edge extend over a circular segment having a segment angle of at least 22°, preferably at least 25°, more preferably at least 30°, and very particularly preferably at least 45°, in particular at least substantially parallel to each other. It is possible to achieve an advantageously large saw tool that can be connected and loaded in a stable manner. In particular, it is possible to achieve a reduction in wear on the saw tool caused by a sawing operation.

It is furthermore proposed that the at least one carrier have at least one carrier connection edge by which the at least one carrier is connected to the at least one hard metal strip, wherein the at least one carrier connection edge has a continuous, curved shape that extends over a circular segment having a segment angle of at least 15°. Preferably, the carrier connection edge extends over a circular segment having the same segment angle as the strip connection edge.

Preferably, the carrier connection edge and the strip connection edge are parallel to each other. Preferably, the strip connection edge and the carrier connection edge are connected to each other via the diffusion joint. Preferably, the strip connection edge and the carrier connection edge are mutually complementary, in particular mutually opposite, such as, for example, each with a wave crest to a wave trough in the case of undulated edges. It is conceivable for the at least one carrier connection edge to extend over a circular segment having a segment angle of at least 15°, preferably at least 20°, particularly preferably at least 30°, and very particularly preferably at least 45°, in particular parallel to the strip connection edge. A particularly advantageous joint, in particular diffusion joint, of the at least one carrier to the at least one hard metal strip can be achieved. Advantageously, the entire strip connection edge can be used to connect the at least one carrier to the at least one hard metal strip.

Also proposed is a power tool system comprising at least one power tool, in particular a multifunctional power tool that can be driven in oscillation, and comprising a saw tool. Preferably, the power tool system comprises at least one charging unit that is designed to supply the power tool with electrical energy. “Designed” is to be understood to mean, in particular, specially configured, specially devised and/or specially equipped. That an object is designed for a particular function, is to be understood to mean, in particular, that the object fulfils and/or executes this particular function in at least one application state and/or operating state. The charging unit may be realized as a cable for a direct electric power supply. The power tool may comprise a battery unit for supplying electrical energy to a motor of the power tool. The charging unit may be realized as a charging station or charging cable for the battery unit of the power tool. A power tool system can be achieved that is advantageously precisely matched to the saw tool.

It is advantageously possible to make available a combination of a power tool, for use of the saw tool, that in particular can provide a power with which the saw tool can be driven for an energy-saving and/or low-wear sawing operation.

There is furthermore proposed a method for producing a saw tool, wherein, in at least one method step, the at least one hard metal strip is connected to the at least one carrier. Preferably, in at least one method step, the at least one hard metal strip is connected to the at least one carrier by means of a joining process with the supply of heat, in particular soldering and/or welding. Preferably, in at least one method step, the at least one hard metal strip is connected along the strip connection edge to the carrier connection edge of the at least one carrier. Preferably, in at least one method step, a diffusion zone is realized between the strip connection edge and the carrier connection edge. It is conceivable that, in at least one method step, at least one tungsten component, in particular in percentage by weight, can be controlled in the diffusion zone, in particular in dependence on the tungsten component relative to the hard metal strip. Preferably, in at least one method step, the diffusion zone is realized with a minimum extent of at least 100 μm, preferably at least 200 μm, more preferably at least 300 μm, and very particularly preferably at least 400 μm between the at least one hard metal strip and the at least one carrier.

Preferably, in at least one method step, the diffusion zone, in particular curved diffusion zone, is realized, from the hard metal strip in the direction of the carrier, with a decreasing profile of the tungsten component, in particular decreasing logarithmically as the distance from the hard metal strip increases. Preferably, in at least one method step, the diffusion zone, in particular curved diffusion zone, is realized with a maximum tungsten component of 19% at a maximum distance of at most 0.2 mm from the strip connection edge. Preferably, in at least one method step, the diffusion zone, in particular curved diffusion zone, is realized with a minimum tungsten component of at least 14% at a maximum distance of at most 0.2 mm from the strip connection edge.

Preferably, in at least one method step, the diffusion zone, in particular curved diffusion zone, is realized with a minimum tungsten component of at least 4% at a maximum distance of between 0.2 mm and 0.35 mm from the strip connection edge. Preferably, in at least one method step, the diffusion zone, in particular curved diffusion zone, is realized with a maximum tungsten component of at most 8% at a distance of between 0.2 mm and 0.35 mm from the strip connection edge. Preferably, in at least one method step, the diffusion zone, in particular curved diffusion zone, is realized with a minimum tungsten component of at least 1% at a distance of between 0.35 mm and 0.41 mm from the strip connection edge. Preferably, in at least one method step, the diffusion zone, in particular curved diffusion zone, is realized with a maximum tungsten component of at most 4% at a distance of between 0.35 mm and 0.41 mm from the strip connection edge. Preferably, in at least one method step, the diffusion zone, in particular curved diffusion zone, is realized with a tungsten component of 4% to 15% at a maximum distance of between 0.2 mm and 0.30 mm from the strip connection edge. Preferably, in at least one method step, the diffusion zone, in particular curved diffusion zone, is realized with a cobalt component of 0.9% to 2.5% at a maximum distance of between 0.2 mm and 0.30 mm from the strip connection edge.

Preferably, in at least one method step, the diffusion zone, in particular curved diffusion zone, is realized with a maximum hardness of, in particular, at most 893 HV 0.5. Preferably, in at least one method step, the diffusion zone, in particular curved diffusion zone, is realized with a minimum hardness of, in particular, at least 427 HV 0.5. Preferably, in at least one method step, the diffusion zone, in particular curved diffusion zone, is realized with an increasing profile of hardness, in particular measured in HV 0.5, from the hard metal strip in the direction of the carrier. Preferably, in at least one method step, the diffusion zone, in particular curved diffusion zone, is realized with an increasing profile of hardness, from the hard metal strip in the direction of the carrier, with at least two plateau regions in which the hardness is at least substantially constant. Preferably, in at least one method step, the diffusion zone, in particular curved diffusion zone, is realized with a minimum hardness of at least 427 HV 0.5 at a maximum distance of at most 0.17 mm from the strip connection edge. Preferably, in at least one method step, the diffusion zone, in particular curved diffusion zone, is realized with a maximum hardness of at most 441 HV 0.5 at a maximum distance of at most 0.17 mm from the strip connection edge. Preferably, in at least one method step, the diffusion zone, in particular curved diffusion zone, is realized with a minimum hardness of at least 851 HV 0.5 at a distance of at least 0.26 mm and at most 0.41 mm from the strip connection edge. Preferably, in at least one method step, the diffusion zone, in particular curved diffusion zone, is realized with a maximum hardness of at most 893 HV 0.5 at a distance of at least 0.26 mm and at most 0.41 mm from the strip connection edge. Preferably, in at least one method step, the diffusion zone, in particular curved diffusion zone, is realized with a minimum hardness of at least 427 HV 0.5 at a distance of at least 0.17 mm and at most 0.26 mm from the strip connection edge. Preferably, in at least one method step, the diffusion zone, in particular curved diffusion zone, is realized with a maximum hardness of at most 893 HV 0.5 at a distance of at least 0.17 mm and at most 0.26 mm from the strip connection edge. Preferably, in at least one method step, the diffusion zone, in particular curved diffusion zone, is realized with an increasing, in particular at least substantially linearly increasing, profile of hardness, in particular measured in HV 0.5, at a distance of at least 0.17 mm and at most 0.26 mm. Preferably, in at least one method step, the diffusion zone, in particular curved diffusion zone, is realized with a lesser hardness, of in particular at most 600 HV 0.5, at a distance of 0.2 mm than at a distance of 0.23 mm, in which the hardness is in particular at most 760 HV 0.5. Preferably, in at least one method step, the hard metal strip is realized with the same hardness, in particular measured in HV 0.5, at its outer edges, in particular at the cutting edge and strip connection edge. It is conceivable for the hard metal strip, in at least one method step, to be realized with different hardnesses, in particular measured in HV 0.5, at its outer edges, in particular at the cutting edge and strip connection edge, in particular if the minimum extent of the hard metal strip between the cutting edge and the strip connection edge is greater than 5 mm.

An advantageously large, in particular curved, diffusion joint can be achieved between the at least one carrier and the at least one hard metal strip.

It is additionally proposed that, in at least one method step, a spatially inhomogeneous depletion of alloy particles be effected in the at least one hard metal strip for the purpose of achieving the diffusion joint. Preferably, in at least one method step, alloy particles, such as tungsten and/or cobalt, are conveyed from the at least one hard metal strip into the diffusion zone of the diffusion joint, in particular as a result of a supply of heat. Preferably, in at least one method step, alloy particles, such as iron, are conveyed from the at least one carrier into the diffusion zone of the diffusion joint, in particular as a result of a supply of heat. Preferably, in at least one method step, alloy particles, such as tungsten and/or cobalt, are conveyed from an alloy region of the at least one hard metal strip that faces toward the strip connection edge into the diffusion zone of the diffusion joint, in particular as a result of a supply of heat. Preferably, the alloy region comprises at most 70%, preferably at most 50%, particularly preferably at most 30%, and very particularly preferably at most 20% of the at least one hard metal strip, starting from the strip connection edge, in the direction of the cutting edge. Preferably, the alloy region is realized at least partially depleted of alloy particles, in particular tungsten and/or cobalt, compared to a cutting region that in particular is arranged at the cutting edge. Preferably, the cutting region comprises at least 30%, preferably at least 50%, particularly preferably at least 70%, and very particularly preferably at least 80% of the at least one hard metal strip, starting from the cutting edge, in the direction of the strip connecting edge. Preferably, the hard metal strip has an increasing proportion of alloy elements, such as tungsten and/or cobalt, starting from the strip connection edge, in the direction of the cutting edge. It is possible to achieve an advantageously narrow hard metal strip, in particular with respect to an extent of the hard metal strip, in particular perpendicularly, between the cutting edge and the strip connection edge, with an advantageously stable diffusion joint on one side and an advantageously robust cutting edge on the opposite side.

The saw tool according to the invention, the power tool system according to the invention and/or the method according to the invention for producing a saw tool are/is not intended in this case to be limited to the application and embodiment described above. In particular, the saw tool according to the invention, the power tool system according to the invention and/or the method according to the invention for producing a saw tool may have a number of individual elements, components and units or method steps that differs from a number stated herein, in order to fulfill an operating principle described herein. Moreover, in the case of the value ranges specified in this disclosure, values lying within the stated limits are also to be deemed as disclosed and applicable in any manner.

### DRAWING

Further advantages are given by the following description of the drawing. Two exemplary embodiments of the invention are represented in the drawing. The drawing, the description and the claims contain numerous features in combination. Persons skilled in the art will also expediently consider the features individually and combine them to create appropriate further combinations.

In the drawing:

FIG. 1 shows a power tool system according to the invention, comprising a power tool and a saw tool, in a schematic representation,

FIG. 2 shows the saw tool according to the invention, in a schematic representation,

FIG. 3 shows a method according to the invention for producing the saw tool according to the invention, in a schematic representation, and

FIG. 4 shows an alternative saw tool according to the invention, in a schematic representation.

### DESCRIPTION OF THE EXEMPLARY EMBODIMENTS

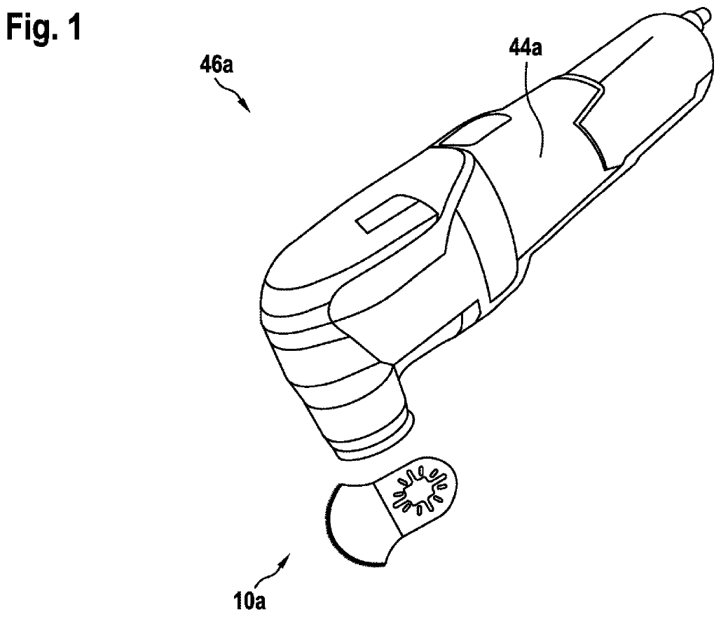

FIG. 1 shows a power tool system 46a comprising at least one power tool 44a and at least one saw tool 10a. The power tool 44a is in particular constituted by a multifunction power tool that can be driven in oscillation.

The power tool system 46a comprises at least one saw tool 10a. The saw tool 10a is in particular realized as a saw blade. The saw tool 10a is designed for the power tool 44a, in particular the multifunctional power tool that can be driven in oscillation.

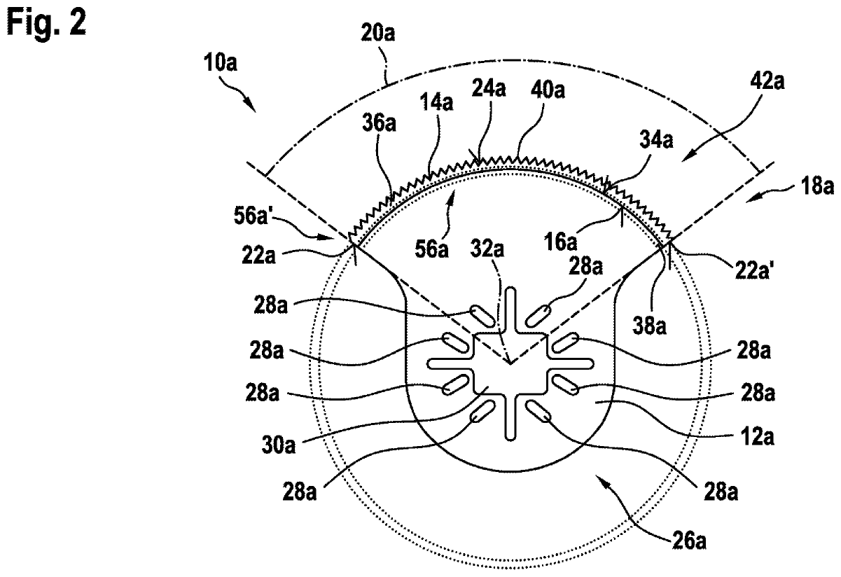

FIG. 2 shows the saw tool with at least one iron-containing carrier 12a and at least one tungsten-containing hard metal strip 14a. The carrier 12a is produced, for example, at least partially, from a steel, a carbide, a ferrous alloy or a ferrous ceramic metal. The hard metal strip 14a is produced, for example, at least partially, from a carbide, a tungsten-containing and/or cobalt-containing ceramic metal, in particular ceramic hard metal, or the like. The carrier 12a has a machine interface 26a. The machine interface 26a is realized as a plurality of recesses 28a through the carrier 12a. The recesses 28a each form a through-hole through the carrier 12a, perpendicularly to the plane of main extent of the carrier 12a. The recesses 28a each have equally sized outer contours. The recesses 28a are arranged symmetrically around a central recess 30a. The central recess 30a has an at least substantially star-shaped outer contour. The at least one carrier 12a has at least one carrier connection edge 34a. The at least one carrier connection edge 34a has a continuous, curved shape. The carrier connection edge 34a extends over a circular segment having a segment angle 20a of at least 15°.

The hard metal strip 14a has a strip connection edge 16a. The strip connection edge 16a is realized at least substantially curved, in particular along a circular arc. The strip connection edge 16a extends over a segment angle 20a of at least 15°. FIG. 2 shows that the strip connection edge 16a is curved along a circular arc. It is conceivable for the strip connection edge 16a to be curved along an ellipse, a circle corresponding in particular to a special case of an ellipse. A mid-point 32a of the central recess 30a of the machine interface 26a realizes, for example, the mid-point 32a of the circle and/or of the ellipse, in particular around which the strip connection edge 16a, in particular the carrier connection edge 34a, is curved. In particular, the mid-point 32a of the central recess 30a realizes a point around which the recesses 28a are arranged with point symmetry. In particular, the mid-point 32a of the central recess 30a realizes a pointed end of the segment angle 20a over which the strip connection edge 16a, in particular the carrier connection edge 34a, extends. The mid-point 32a realizes in particular a drive center from where in particular the saw tool 10a can be driven by the power tool 44a. It is conceivable, in particular in the case of an asymmetrically realized machine interface 26a, for the mid-point 32a of the circle and/or of the ellipse to be realized at a distance from a mid-point of the machine interface 26a.

The at least one hard metal strip 14a has at least one cutting edge 24a. The cutting edge 24a is arranged opposite the at least one strip connection edge 16a. There are saw teeth 40a arranged on the cutting edge 24a. The cutting edge 24a extends over a circular segment having a segment angle 20a of at least 15°. The at least one cutting edge 24a has a continuous, curved shape that is at least substantially parallel to the at least one strip connection edge 16a. The at least one strip connection edge 16a and the at least one cutting edge 24a each extend over a circular segment having a segment angle 20a of at least 15°. FIG. 2 shows that the cutting edge 24a and the strip connection edge 16a are on average at least substantially parallel to each other. The strip connection edge 16a has a lesser maximum extent than the cutting edge 24a.

The hard metal strip 14a is connected to the carrier 12a in a materially bonded manner at the strip connection edge 16a via a diffusion joint. The at least one carrier 12a is connected, at the carrier connection edge 34a, to the at least one hard metal strip 14a, at the strip connection edge 16a, in particular in a materially bonded manner. The diffusion joint has a diffusion zone 18a. The diffusion zone 18a is arranged between the hard metal strip 14a, in particular the strip connection edge 16a, and the carrier 12a, in particular the carrier connection edge 34a. The diffusion zone 18a is realized as a material joining of alloy particles. The diffusion zone 18a is realized as a material union of the carrier 12a and of the hard metal strip 14a. The diffusion zone 18a is realized as a single piece, in particular as a single part, with the carrier 12a and the hard metal strip 14a. The diffusion zone 18a is realized from parts, in particular diffusion particles, of the hard metal strip 14a and of the carrier 12a, in particular by a partial particle erosion from an alloy region 36a of the hard metal strip 14a and a carrier alloy region 38a of the carrier 12a. The alloy region 36a is arranged, on the hard metal strip 14a, at an end that faces toward the strip connection edge 16a, along the maximum extent of the hard metal strip 14a. The carrier alloy region 38a is arranged, on the carrier 12a, at an end that faces toward the carrier connection edge 34a, along the maximum extent of the carrier connection edge 34a. The carrier alloy region 38a has a lesser extent perpendicularly to the maximum extent of the hard metal strip 14a and perpendicularly to the material thickness of the carrier 12a than has the alloy region 36a of the hard metal strip 14a.

The alloy region 36a of the hard metal strip 14a comprises a sub-region of the hard metal strip 14a that has at least 3% fewer alloy particles than the part of the hard metal strip 14a that adjoins the alloy region 36a. In the alloy region 36a, a depletion, in particular of at least 3%, of alloy particles, such as tungsten and/or cobalt, is realized in the at least one hard metal strip 14a. It is conceivable for the depletion of alloy particles in the alloy region 36a to be realized in the at least one hard metal strip 14a in a spatially inhomogeneous manner, in particular as a descending gradient, as a result of a supply of heat to the at least one hard metal strip 14a. It is conceivable for the depletion of alloy particles in the alloy region 36a to be realized as a descending gradient in the direction of a cutting region 42a of the hard metal strip 14a that is arranged in a vicinity of the cutting edge 24a. It is conceivable for the cutting region 42a to be realized without depletion of alloy particles, such as tungsten and/or cobalt.

The diffusion zone 18a has two end edges 22a, 22a′. The end edges 22a, 22a′ are located at the end regions of the maximum extent of the strip connection edge 16a. The end edges 22a, 22a′ are of at least substantially equal lengths. It is conceivable for the lengths of the end edges 22a, 22a′ to be realized selectively. It is conceivable that the lengths of the end edges 22a, 22a′ can be realized selectively, in particular by an input of heat that is focused in particular spatially, homogeneously and/or in particular spatially and/or temporally, for the purpose of achieving the diffusion joint of the hard metal strip 14a to the carrier 12a.

It is conceivable for the end edges 22a, 22a′ to be of different lengths, in particular depending on an accuracy of a heat input. It is conceivable for the end edges 22a, 22a′ to be realized, by very short temporally focused heat pulses in a soldering process and/or welding process, so as to be at least substantially of the same length. It is also conceivable for the end edges 22a, 22a′ to be realized, by spatially focused heat pulses, in particular by micro soldering tools and/or micro welding tools, in a soldering process and/or welding process, so as to be at least substantially of the same length. It is also conceivable for the end edges 22a, 22a′ to be realized, by spatially focused light pulses for input of heat, so as to be at least substantially of the same length. It is conceivable for the end edges 22a, 22a′ to be of at least substantially equal lengths that are realized by means of a temporally and/or spatially controlled supply of heat into the hard metal strip 14a and/or into the carrier 12a.

The diffusion zone 18a has two main end edges 56a, 56a′. The main end edges 56a, 56a′ are located along the maximum extent of the strip connection edge 16a. The main end edges 56a, 56a′ are of at least substantially equal lengths, in particular extents from the strip connection edge 16a to the carrier connection edge 34a. The length of the main end edge 56a, 56a′ is in particular the maximum extent of the main end edge 56a, 56a′ from the strip connection edge 16a to the carrier connection edge 34a. It is conceivable that the lengths, in particular extents from the strip connection edge 16a to the carrier connection edge 34a, of the main end edges 56a, 56a′ can be realized selectively. It is conceivable that the lengths of the main end edges 56a, 56a′ can be realized selectively, in particular by an input of heat that is focused in particular spatially, homogeneously and/or in particular spatially and/or temporally, for the purpose of achieving the diffusion joint of the hard metal strip 14a to the carrier 12a. It is conceivable that the main end edges 56a, 56a′ to be different lengths, in particular depending on an accuracy of a heat input.

It is conceivable that the main end edges 56a, 56a′ to be realized, by very short temporally focused heat pulses in a soldering process and/or welding process, so as to be at least substantially the same length. It is also conceivable for the main end edges 56a, 56a′ to be realized, by spatially focused heat pulses, in particular by micro soldering tools and/or micro welding tools, in a soldering process and/or welding process, so as to be at least substantially of the same length. It is also conceivable that the main end edges 56a, 56a′ to be realized, by spatially focused light pulses for input of heat, so as to be at least substantially of the same length. It is conceivable for the main end edges 56a, 56a′ to be of at least substantially equal lengths that are realized by means of a temporally and/or spatially controlled supply of heat into the hard metal strip 14a and/or into the carrier 12a.

It is conceivable for the hard metal strip 14a, at the cutting edge 24a, to be of a greater extent, in particular thickness, perpendicularly to the cutting edge 24a than at the strip connection edge 16a. It is also conceivable for the hard metal strip 14a, at the cutting edge 24a, to be of a lesser or equal extent, in particular thickness, at the cutting edge 24a perpendicularly to the cutting edge 24a than at the strip connection edge 16a.

It is conceivable for the hard metal strip 14a, at the cutting edge 24a, to have a stiffness that differs from a stiffness at the strip connection edge 16a, in particular in the alloy region 36a. It is conceivable for the hard metal strip 14a to be eroded, in particular depleted of alloy elements, at an end edge 22a, 22a′. It is conceivable for one end edge 22a, 22a′ is realized so as to be the same length, up to 0.5 cm, as the respectively other end edge 22a, 22a′. It is conceivable for a greater tungsten component to be diffused into the diffusion zone 18a from a sub-region of the alloy region 36a of the hard metal strip 14a at one, in particular longer, end edge 22a, 22a′ than from other sub-regions of the alloy region 36a. It is also conceivable for the hard metal strip 14a to be completely eroded, in particular angled, at an end edge 22a, 22a′ and to adjoin a longer end edge 22a, 22a′.

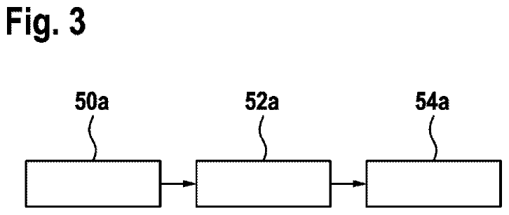

FIG. 3 shows a method for producing a saw tool 10a. In at least one method step, in particular a bending step 50a, the hard metal strip 14a is curved, in particular by a mechanical deformation process. Preferably, in at least one method step, in particular the one bending step 50a, the hard metal strip 14a is curved over its entire main extent along an ellipse, in particular along a circle, in particular over a segment angle 20a of at least 15°, preferably at least 20°, in particular at least 45°. FIG. 2 shows a segment angle 20a of about 100°. Preferably, in at least one method step, in particular the one bending step 50a, the at least one hard metal strip 14a is curved over its entire main extent in a single bending process. It is conceivable for heat to be input into the hard metal strip 14a, for the purpose of increasing flexibility, in at least one method step, in particular the at least one bending step 50a. It is conceivable for the hard metal strip 14a to be curved in sections in a temporally staggered manner, in particular until the hard metal strip 14a is curved over its entire main extent, in at least one method step, in particular the at least one bending step 50a.

In at least one method step, in particular a connection step 52a, the at least one hard metal strip 14a is connected to the at least one carrier 12a. In at least one method step, in particular the at least one connection step 52a, the at least one hard metal strip 14a is connected to the at least one carrier 12a by a joining process such as, for example, soldering and/or welding. In at least one method step, in particular the at least one connection step 52a, the input of heat is controlled for the purpose of precisely achieving the tungsten component, in particular in dependence on the distance in the diffusion zone 18a from the strip connection edge 16a, in particular with an accuracy deviation of at most 1%, in the diffusion zone 18a. In at least one method step, in particular the at least one bonding step 52a, the tungsten component, in particular in percentage by weight, in the diffusion zone 18a is selectively controlled, in particular in dependence on the distance in the diffusion zone 18a from the hard metal strip 14a, in particular with an accuracy tolerance of at most 0.02 mm. In at least one method step, in particular the at least one connection step 52a, the hardness, in particular measured in HV 0.5, in the diffusion zone 18a is selectively controlled, in particular in dependence on the distance in the diffusion zone 18a from the hard metal strip 14a, in particular with an accuracy tolerance of at most 0.02 mm. In at least one method step, in particular the one connection step 52a, a spatially inhomogeneous depletion of alloy particles is realized in the at least one hard metal strip 14a for the purpose of achieving the diffusion joint. In at least one method step, in particular the one connection step 52a, a cutting edge region that is arranged opposite the at least one strip connection edge 16a on the at least one hard metal strip 14a is realized at least substantially without depletion of alloy particles. It is conceivable for at least one hard metal strip 14a to be connected to the at least one carrier 12a by a welding process without any soldering element, such as a solder wire, preferably a solder wire having a tin component, in at least one method step, in particular the at least one connection step 52a.

In at least one method step, in particular a tooth step 54a, saw teeth 40a are made in the hard metal strip 14a by a forming process such as, for example, a turning process, drilling process, punching process, grinding process and/or milling process. In at least one method step, in particular the tooth step 54a, saw teeth 40a are made in the hard metal strip 14a at the cutting edge 24a of the hard metal strip 14a. In at least one method step, in particular the tooth step 54a, saw teeth 40a are at the cutting edge 24a over a segment angle 20a of at least 15°, preferably at least 45°. In at least one method step, in particular the tooth step 54a, at least five, in particular at least ten, preferably at least fourteen, particularly preferably at least twenty, saw teeth 40a are made in the hard metal strip 14a.

It is conceivable that in at least one method step, in particular the one connection step 52a, an input of heat is controlled to reduce the hardness, in particular measured in HV 0.5, in particular stiffness, of the hard metal strip 14a in a region of the hard metal strip 14a, in particular in order to ensure a tungsten component of from 6% to 25% in the diffusion zone 18a.

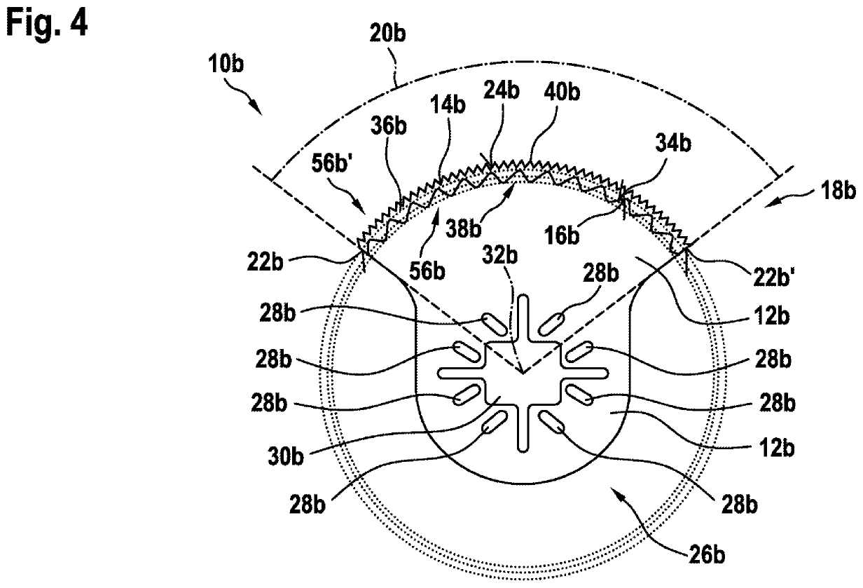

FIG. 4 shows a further exemplary embodiment of the invention. The following descriptions and the drawings are limited substantially to the differences between the exemplary embodiments and, in principle, reference may also be made to the drawings and/or the description of the other exemplary embodiment, in particular of FIGS. 1 and 2, in respect of components having the same designation, in particular in respect of components denoted by the same references. To distinguish the exemplary embodiments, the letter a has been appended to the references of the exemplary embodiment in FIGS. 1 and 2. In the exemplary embodiments of FIG. 3, the letter a is replaced by the letters b to f.

FIG. 3 shows a further exemplary embodiment of the saw tool 10b. FIG. 3 shows in particular that the strip connection edge 16b is at least substantially undulated. The carrier connection edge 34b is at least substantially realized in an undulating manner. The strip connection edge 16a and the carrier connection edge 34a each have a mean course, in particular a quadratic mean. The strip connection edge 16b and the carrier connection edge 34b are realized so as to fit each other precisely, in particular complementarily. In particular, the wave crests of the strip connection edge 16b and the wave troughs of the carrier connection edge 34b are arranged opposite each other. In particular, the wave troughs of the strip connection edge 16b and the wave crests of the carrier connection edge 34b are arranged opposite each other. FIG. 3 shows that the cutting edge 24b and the strip connection edge 16b are on average at least substantially parallel to each other. The mean courses, in particular the quadratic means, of the strip connection edge 16b and of the carrier connection edge 34b are at least substantially parallel to each other.

1. A saw blade, for a multifunctional power tool configured to be driven in oscillation, comprising:
at least one iron-containing carrier; and
at least one tungsten-containing hard metal strip that has a strip connection edge, wherein
the at least one tungsten-containing hard metal strip is connected to the at least one iron-containing carrier at the strip connection edge in a materially bonded manner via a diffusion joint that has at least one diffusion zone, and
the strip connection edge is at least substantially curved along a circular arc.

2. The saw blade as claimed in claim 1, wherein the strip connection edge extends over a segment angle of at least 15°.

3. The saw tool as claimed in claim 1, wherein:
the at least one diffusion zone has two end edges that are located at the end regions of the maximum extent of the strip connection edge; and
the end edges are of at least substantially equal lengths.

4. The saw tool as claimed in claim 1, wherein the at least one tungsten-containing hard metal strip has, opposite the strip connection edge, at least one cutting edge on which cutting teeth are arranged and which extends over a circular segment having a segment angle of at least 15°.

5. The saw tool as claimed in claim 1, wherein the strip connection edge is at least substantially undulated.

6. The saw tool as claimed in claim 1, wherein:
the at least one tungsten-containing hard metal strip has at least one cutting edge opposite the strip connection edge;
the at least one cutting edge and the strip connection edge are on average at least substantially parallel to each other; and
the strip connection edge has a lesser maximum extent than the at least one cutting edge.

7. The saw tool as claimed in claim 1, wherein:
the at least one tungsten-containing hard metal strip has at least one cutting edge opposite the strip connection edge;
the at least one cutting edge has a continuous, curved shape that is at least substantially parallel to the strip connection edge; and
the strip connection edge and the at least one cutting edge each extend over a circular segment having a segment angle of at least 15°.

8. The saw tool as claimed in claim 1, wherein:
the at least one iron-containing carrier has at least one carrier connection edge by which the at least one iron-containing carrier is connected to the at least one tungsten-containing hard metal strip; and
the at least one iron-containing carrier connection edge has a continuous, curved shape that extends over a circular segment having a segment angle of at least 15°.

9. A power tool system comprising:
at least one multifunctional power tool that can be driven in oscillation;
at least one saw blade as claimed in claim 1.

10. A method for producing a saw blade as claimed in claim 1, comprising:
connecting the at least one tungsten-containing hard metal strip to the at least one iron-containing carrier.

11. The method as claimed in claim 10, further comprising:
effecting a spatially inhomogeneous depletion of alloy particles in the at least one tungsten-containing hard metal strip to achieve the diffusion joint.
